(19) United States
(12) Patent Application Publication
(10) Pub. No.: US 2025/0309584 A1
(43) Pub. Date: Oct. 2, 2025

(54) CONNECTOR

(71) Applicant: SUMITOMO WIRING SYSTEMS, LTD., Mie (JP)

(72) Inventor: Risa NAGANAWA, Mie (JP)

(21) Appl. No.: 18/866,074

(22) PCT Filed: May 1, 2023
(86) PCT No.: PCT/JP2023/017071

§ 371 Date: Nov. 15, 2024

(30) Foreign Application Priority Data
May 20, 2022 (JP) 2022-082845

(51) Int. Cl. H01R 13/627

(52) U.S. Cl. CPC H01R 13/6272

(57) ABSTRACT

A housing includes a lock arm extending from a front end to a rear end in a connection direction to a mating housing, resiliently deformable in an intersecting direction intersecting the connection direction and to be locked to the mating housing, an end surface arranged to face a rear end part of the lock arm in the intersecting direction, a pair of side portions projecting on the end surface and arranged on both sides across the rear end part of the lock arm, and a covering portion bridged between the pair of side portions and covering the rear end part of the lock arm from a side opposite to the end surface. A step portion is formed to face rearward on a top surface opposite to a surface facing the lock arm in the covering portion.

### TECHNICAL FIELD

The present disclosure relates to a connector.

### BACKGROUND

A connector described in Patent Document 1 is provided with a housing, a lock arm formed on the upper wall of the housing, a pair of plate-like support walls arranged on both sides of a rear end part of the lock arm and a coupling portion bridged between the respective plate-like support walls for covering a part of the rear end part of the lock arm. A locking space is formed in the rear end of the coupling portion.

A connector described in Patent Document 2 is provided with a housing, a lock arm formed on the upper surface of the housing, an upper surface side protecting portion for covering a rear end part of the lock arm from above and a pair of side surface side protecting portions for covering the rear end part of the lock arm from both left and right sides.

In Patent Document 1 and 2, the rear end part of the lock arm is configured as an operating portion (described as a “locking portion” in Patent Document 1). A worker can release the connection of the housing and a mating housing by pressing the upper surface of the operating portion with a finger.

A lock arm including such an operating portion is also disclosed in Patent Document 3 and 4. Patent Document 3 discloses a technique for improving workability by including a second lock protection wall for covering a base end side of the lock arm. Patent Document 4 discloses a technique for enhancing a collision sound (described as a “connection sound” in Patent Document 4) generated as the lock arm resiliently returns. This connection sound is a sound generated by the resiliently returning lock arm striking a wall surface of a mating housing when the housing and the mating housing reach a proper connection position.

### PRIOR ART DOCUMENT

### Patent Document

Patent Document 1: JP 2021-190298 A
Patent Document 2: JP 2020-057578 A
Patent Document 3: JP 2008-066030 A
Patent Document 4: JP 2005-158417 A

### SUMMARY OF THE INVENTION

### Problems to be Solved

In the case of Patent Document 1, when the housing and the mating housing are connected, the worker's finger may erroneously contact the upper surface of the operating portion through the locking space and the housing may reach a proper connection position with the operating portion pushed down. There has been a situation where the lock arm cannot resiliently return with a proper resilient reaction force even if the worker's finger is removed from the operating portion after the housing reaches the connection position in this way. Thus, there has been a concern that the above connection sound is reduced and auditory detection for connection does not function.

In contrast, in the case of Patent Document 2, since the upper surface side protecting portion covers the rear end part of the lock arm from above, the contact of the worker's finger with the rear end part of the lock arm can be avoided. Thus, in the case of Patent Document 2, it is possible to generate a connection sound. However, if an attempt is made to connect the housing and the mating housing by placing the worker's finger on the upper surface of the upper surface side protecting portion, the finger may slip on the upper surface of the upper surface side protecting portion and it may not be possible to smoothly perform an operation.

Accordingly, the present disclosure aims to provide a connector capable of properly generating a connection sound and smoothly performing a connecting operation.

### Means to Solve the Problem

The present disclosure is directed to a connector with a housing to be connected to a mating housing, the housing including a lock arm extending from a front end to a rear end in a connection direction to the mating housing, the lock arm being resiliently deformable in an intersecting direction intersecting the connection direction, the lock arm being locked to the mating housing, an end surface arranged to face a rear end part of the lock arm including the rear end in the intersecting direction, a pair of side portions projecting on the end surface, the pair of side portions being arranged on both sides across the rear end part of the lock arm, a covering portion bridged between the pair of side portions, the covering portion covering the rear end part of the lock arm from a side opposite to the end surface, and a step portion formed to face rearward on a top surface opposite to a surface facing the lock arm in the covering portion.

### Effect of the Invention

According to the present disclosure, it is possible to provide a connector capable of properly generating a connection sound and smoothly performing a connecting operation.

### BRIEF DESCRIPTION OF THE DRAWINGS

FIG. 1 is a perspective view of a connector when viewed obliquely from an upper front side in one embodiment of the present disclosure.

FIG. 2 is a section of the connector.

FIG. 3 is a perspective view of a housing when viewed obliquely from an upper rear side.

FIG. 4 is a back view of the housing.

FIG. 5 is a partial section enlargedly showing a part including an operating portion and a covering portion in the housing.

### DETAILED DESCRIPTION TO EXECUTE THE INVENTION

### Description of Embodiments of Present Disclosure

First, embodiments of the present disclosure are listed and described below.
(1) The connector of the present disclosure is provided with a housing to be connected to a mating housing, the housing including a lock arm extending from a front end to a rear end in a connection direction to the mating housing, the lock arm being resiliently deformable in an intersecting direction intersecting the connection direction, the lock arm being locked to the mating housing, an end surface arranged to face a rear end part of the lock arm including the rear end in the intersecting direction, a pair of side portions projecting on the end surface, the pair of side portions being arranged on both sides across the rear end part of the lock arm, a covering portion bridged between the pair of side portions, the covering portion covering the rear end part of the lock arm from a side opposite to the end surface, and a step portion formed to face rearward on a top surface opposite to a surface facing the lock arm in the covering portion.

According to the above configuration, when the housing and the mating housing are connected, a worker's finger is placed on the top surface of the covering portion, whereby the finger can be prevented from contacting the rear end part of the lock arm. As a result, it can be avoided that the lock arm is inadvertently resiliently deformed, and the lock arm can properly resiliently return and generate a proper connection sound when the housing reaches a proper connection position. Moreover, since the step portion provides an anti-slip function for the finger when the housing is pushed into the mating housing, a connecting operation can be smoothly performed.
(2) Preferably, the rear end part of the lock arm is arranged at a position more separated from the end surface than a part of the lock arm except the rear end part, and the covering portion is formed to cover the entire rear end part of the lock arm when viewed from the side opposite to the end surface.

According to the above configuration, the worker's finger is more easily placed on the top surface of the covering portion, whereas the contact of the finger with the rear end part of the lock arm can be more reliably prevented.
(3) A plurality of the step portions may be formed side by side in the connection direction on the top surface of the covering portion.

According to the above configuration, the plurality of step portions can provide a more effective anti-slip function for the finger.
(4) The step portion may be formed into a trapezoidal or U shape when viewed from the side opposite to the end surface.

According to the above configuration, since the worker's finger can be placed along the trapezoidal or U-shaped step portion in placing the finger on the top surface of the covering portion, a large hooking margin of the finger to the step portion can be taken. As a result, the trapezoidal or U-shaped step portion can provide a more effective anti-slip function for the finger.
(5) A plurality of the step portions may be formed side by side in the connection direction on the top surface of the covering portion and each may be formed into a trapezoidal or U shape when viewed from the side opposite to the end surface and have a ripple shape as a whole.

According to the above configuration, the plurality of trapezoidal or U-shaped step portions can provide an even more effective anti-slip function for the finger. Further, since being formed into a ripple shape as a whole, each step portion is more easily recognized as a part, on which the finger is to be placed.
(6) The rear end part of the lock arm may include a groove portion inclined in a direction away from the covering portion toward the rear side in a facing surface facing the covering portion.

According to the above configuration, when the housing is at the proper connection position, the lock arm can be resiliently deformed in an unlocking direction by placing a jig or the like along the groove portion of the rear end part of the lock arm. Thus, even if the rear end part of the lock arm is covered by the covering portion, the connection of the housing and the mating housing can be properly released.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

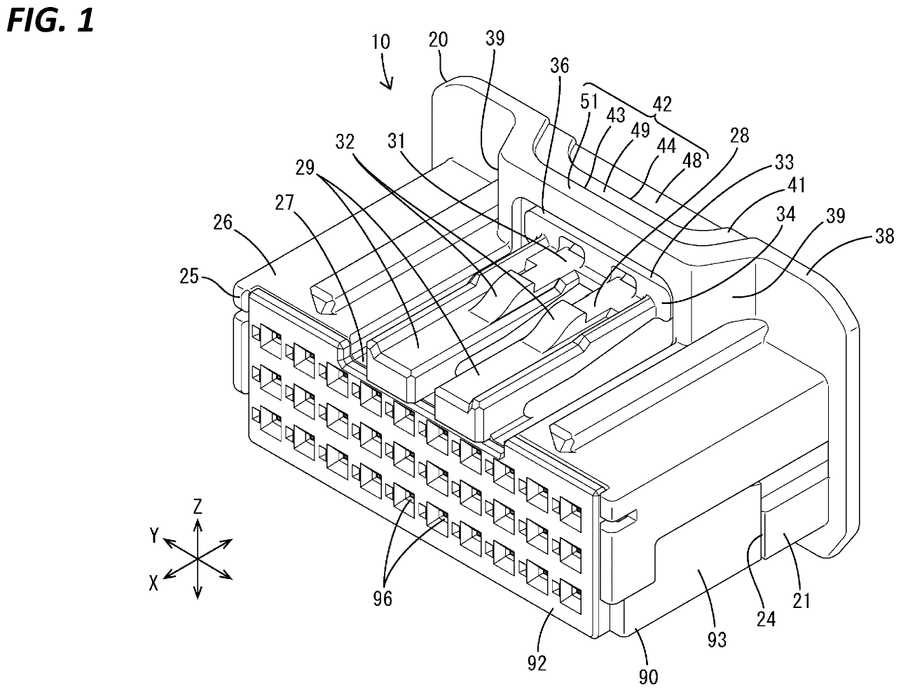

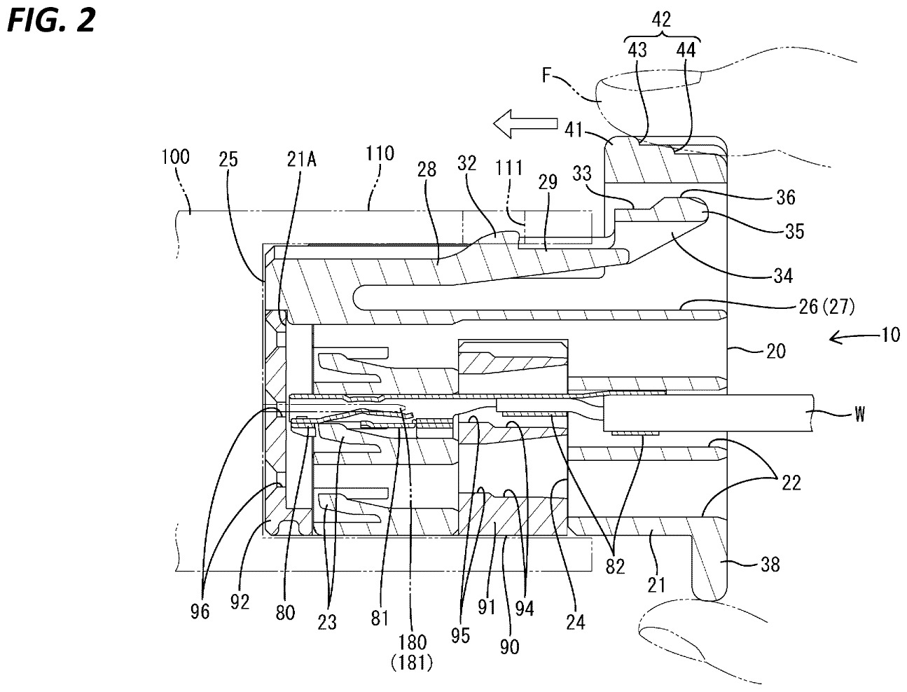

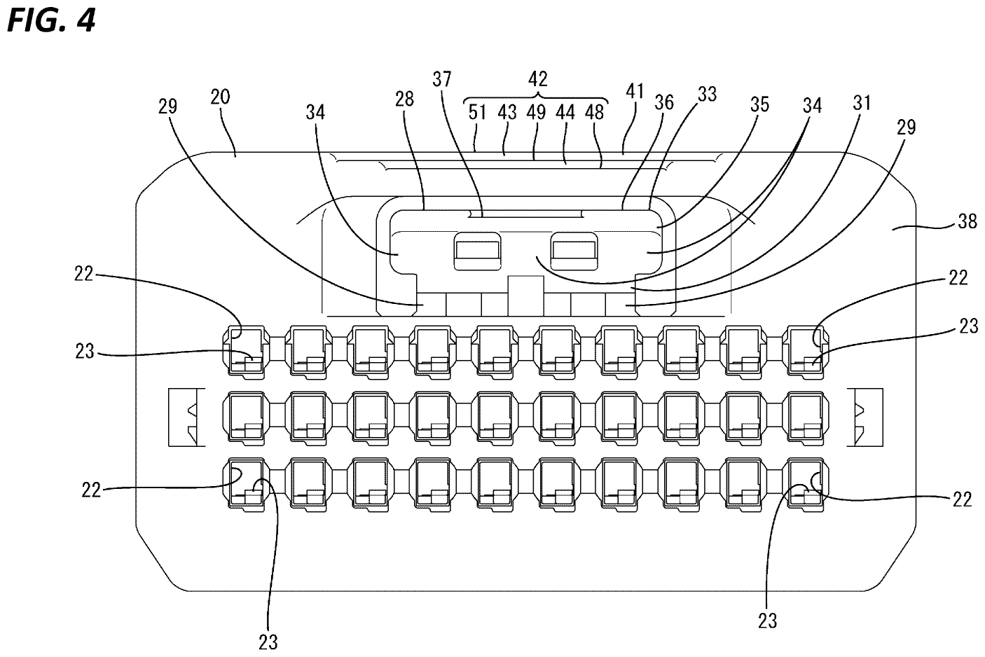

A connector 10 according to one embodiment of the present disclosure is provided with terminal fittings 80, a housing 20 and a retainer 90. As shown in FIG. 2, the housing 20 is connectable to a mating housing 100. Note that, in the following description, a side of the housing 20 to be connected to the mating housing 100, in particular, a side of the housing 20 facing the mating housing 100 at the start of connection, is referred to as a front side concerning a front-rear direction. A left side of FIG. 2 is the front side. A vertical direction is based on a vertical direction of each figure. This vertical direction does not necessarily coincide with a direction of gravity in a state where the connector 10 is installed in a vehicle or the like. A lateral direction is based on a lateral direction of FIG. 4. In FIG. 1, X, Y and Z respectively represent the front-rear direction, the lateral direction and the vertical direction. Further, in the following description, a front end part means a part on a front side including a front end, and a rear end part means a part on a rear side including a rear end.

### (Terminal Fitting)

The terminal fitting 80 is integrally formed, such as by bending an electrically conductive metal plate. As shown in FIG. 2, the terminal fitting 80 has a shape elongated in the front-rear direction and includes a connecting portion 81 in a front end part and a barrel portion 82 in a rear end part. The connecting portion 81 is in the form of a rectangular tube, receives a tab 181 of a mating terminal fitting 180 mounted in the mating housing 100 and is electrically connected to the mating terminal fitting 180. The barrel portion 82 is crimped to an end part of a wire W and electrically and mechanically connected to the wire W.

### (Housing)

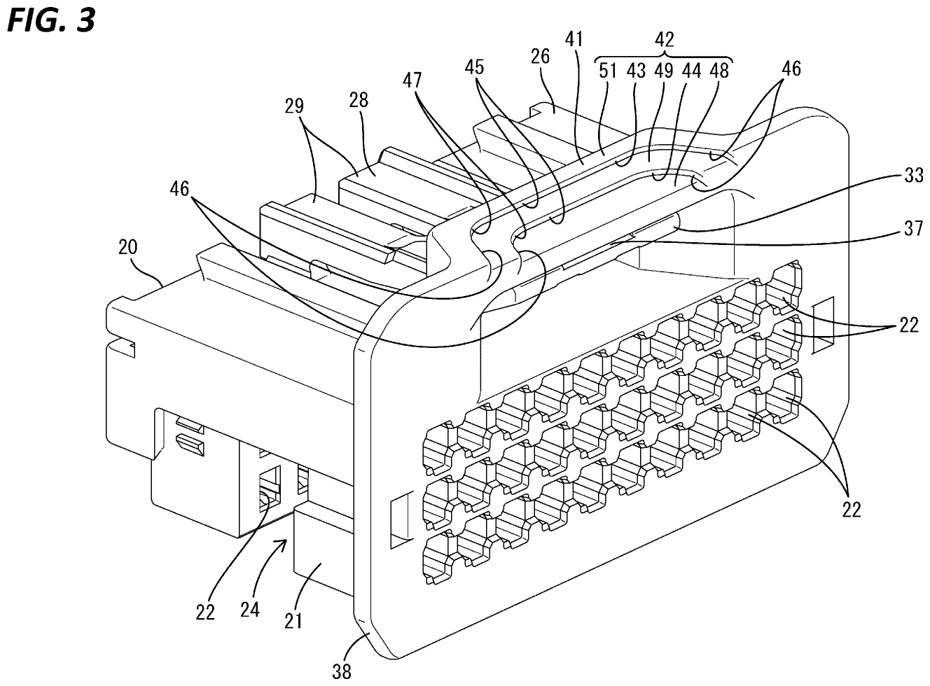

The housing 20 is made of synthetic resin and includes, as shown in FIGS. 1 and 3, a housing body 21 having a rectangular plan view shape long in the lateral direction. As shown in FIG. 2, the housing body 21 includes a plurality of cavities 22 extending in the front-rear direction. A locking lance 23 is formed to project on the inner wall of each cavity 22. The terminal fitting 80 is inserted into the cavity 22 from behind and primarily retained in the housing body 21 by locking the connecting portion 81 by the locking lance 23. The wire W is pulled out rearward from the cavity 22 of the housing body 21.

The housing body 21 includes a retainer mount hole 24 open in the left and right side surfaces and the lower surface of the housing body 21 in an intermediate part in the front-rear direction. Each cavity 22 is divided into front and rear parts via the retainer mount hole 24 inside the housing 21 (see FIG. 3). As shown in FIG. 1, the housing body 21 includes a projecting wall 25 formed from an upper front end part to left and right front end parts. A front surface 21A of the housing body 21 is arranged at a position retracted in the front-rear direction and corresponding to the rear end of the projecting wall 25 (see FIG. 2).

As shown in FIG. 1, the upper surface of the housing body 21 is configured as an end surface 26 facing upward. The end surface 26 of the housing body 21 has a recessed surface 27 slightly recessed from both sides in the lateral direction in an intermediate part in the lateral direction. The housing 20 includes a lock arm 28 projecting from the recessed surface 27 of the housing body 21. The lock arm 28 includes a pair of arm bodies 29 arranged at an interval in the lateral direction and a coupling portion 31 coupled to the rear ends of the respective arm bodies 29.

The respective arm bodies 29 are in the form of plates extending in the front-rear direction and arranged in parallel to each other. A front end part of each arm body 29 is coupled to an upper front end part of the recessed surface 27 of the housing body 21 and constitutes a part of the projecting wall 25. The lock arm 28 is resiliently deformable in the vertical direction with a front end part of each arm body 29 as a fulcrum. A lock projection 32 is formed to project on the upper surface of each arm body 29. As shown in FIG. 2, the lock projections 32 are fit into lock holes 111 formed in the receptacle 110 of the mating housing 100, whereby the housing 20 and the mating housing 100 are held in the connected state. As shown in FIGS. 1 and 4, the coupling portion 31 is in the form of a rib extending in the lateral direction and end parts in the lateral direction are respectively coupled to the rear ends of the respective arm bodies 29.

As shown in FIG. 4, the lock arm 28 includes an operating portion 33 projecting upward from the coupling portion 31. The operating portion 33 includes short leg portions 34 rising at a plurality of positions spaced apart in the lateral direction, three positions in the shown example, and an operating body 35 coupled to the upper end of each leg portion 34.

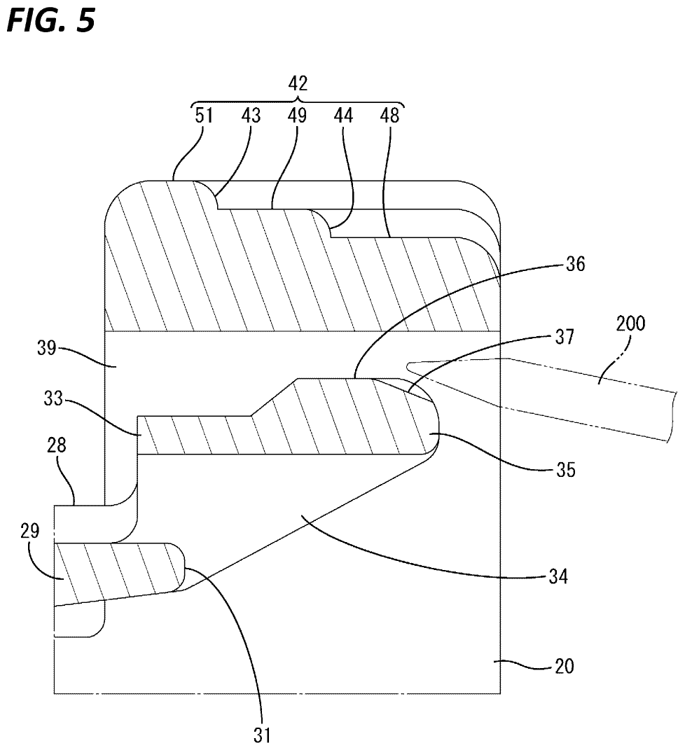

The respective leg portions 34 are arranged at positions corresponding to the respective arm bodies 29 and a position between the respective arm bodies 29 in the lateral direction. As shown in FIGS. 2 and 5, the rear surface of the leg portion 34 is shaped into a slope inclined rearward toward an upper side. As shown in FIG. 4, the operating body 35 is in the form of a plate extending in the lateral direction and end parts and an intermediate part in the lateral direction thereof are respectively coupled to the upper end of the coupling portion 31. The upper surface of the operating body 35 is arranged at a position higher than the upper surface of each of the arm bodies 29 and the coupling portion 31 and serves as a facing surface 36 facing a covering portion 41 to be described later.

As shown in FIGS. 2 and 5, a rear end part of the operating body 35 is formed to be thicker than a front end part of the operating body 35. As shown in FIG. 4, the rear end part of the operating body 35 is cut to form a groove portion 37 in an intermediate part in the lateral direction of the facing surface 36. The groove portion 37 has a constant width in the lateral direction in the facing surface 36 of the rear end part of the operating body 35 and is shaped into a slope inclined downward toward a rear side as shown in FIG. 5.

The housing 20 includes a flange portion 38 protruding from a rear end part of the housing body 21 over an entire periphery. As shown in FIG. 4, the flange portion 38 has a rectangular external shape with four chamfered corners in a back view.

As shown in FIG. 1, the housing 20 includes a pair of side portions 39 covering the operating portion 33 from lateral sides on both left and right sides across the operating portion 33 of the lock arm 28. Each side portion 39 projects from the end surface 26 of the housing body 21 and a rear end part thereof is integrated with the flange portion 38. The respective side portions 39 have a tapered shape to reduce a distance therebetween toward the front in a plan view.

The housing 20 includes the covering portion 41 coupled to the upper ends of the respective side portions 39 and bridged between the respective side portions 39. A rear end part of the covering portion 41 is integrated with the flange portion 38. The covering portion 41 has a trapezoidal or U-shaped external shape narrowed toward the front in a plan view.

The front and rear ends of the covering portion 41 are arranged along the lateral direction. As shown in FIG. 2, the front end of the covering portion 41 is arranged at a position overlapping the respective arm bodies 29 in the front-rear direction. The rear end of the covering portion 41 is arranged at the same position as the rear end of the housing body 21 in the front-rear direction.

The covering portion 41 is located above the operating portion 33 and arranged to cover the operating portion 33 from above. In other words, the covering portion 41 is arranged to face the entire facing surface 36 of the operating portion 33 while being spaced apart. The entire operating portion 33 is concealed by the covering portion 41 in a plan view of the housing 20.

As shown in FIG. 2, the upper surface of the covering portion 41 serves as a top surface 42, on which a finger F of a worker is to be placed in connecting the housing 20 and the mating housing 100. The top surface 42 of the covering portion 41 is formed with a plurality of step portions 43, 44. Each of the step portions 43, 44 is arranged to face rearward. As shown in FIG. 5, each of the step portions 43, 44 is formed into a curved surface inclined forward with respect to the vertical direction. Further, as shown in FIG. 3, each step portion 43, 44 has a trapezoidal or U shape in a plan view and includes a straight portion 45 extending along the lateral direction and a pair of inclined portions 46, which are more spaced apart toward the rear side. The front ends of the respective inclined portions 46 and the left and right ends of the straight portion 45 are respectively coupled via corner portions 47 curved in the plan view. The rear end of each inclined portion 46 is located on the rear end of the covering portion 41. Each step portion 43, 44 is similar in external shape to the covering portion 41 and has a ripple shape as a whole in the plan view.

In the case of this embodiment, the step portions 43, 44 include a first step portion 43 and a second step portion 44. The straight portion 45 of the first step portion 43 is arranged in front of the straight portion 45 of the second step portion 44. The corner portions 47 of the second step portion 44 have a larger radius of curvature than the corner portions 47 of the first step portion 43.

As shown in FIGS. 1 and 3, the top surface 42 of the covering portion 41 is formed with a third flat surface 48 behind the second step portion 44, a second flat surface 49 between the first and second step portions 43, 44 and a first flat surface 51 in front of the first step portion 43. Any of the first, second and third flat surfaces 51, 49, 48 is arranged to face upward and formed to be flat along the front-rear direction and lateral direction.

The second flat surface 49 is arranged at a position higher than the third flat surface 48 via the second step portion 44. The first flat surface 51 is arranged at a position higher than the second flat surface 49 via the first step portion 43. The first step portion 43 is arranged at a position higher than the second step portion 44 via the second flat surface 49. In short, the top surface 42 of the covering portion 41 is formed into ascending steps toward the front in a cross-section of the housing 20 as shown in FIG. 5.

### (Retainer)

The retainer 90 is made of synthetic resin and includes, as shown in FIG. 2, a retainer body 91, a front mask portion 92 and a pair of side walls 93 (only one is shown in FIG. 1).

As shown in FIG. 2, the retainer body 91 is in the form of a rectangular block and inserted into the retainer mount hole 24. The retainer body 91 includes a plurality of through holes 94 configured to communicate with the respective cavities 22 and a plurality of retaining portions 95 for secondarily retaining the respective terminal fittings 80.

The front mask portion 92 is plate-like and arranged to face the front surface 21A of the housing body 21. The front mask portion 92 includes a plurality of tab insertion holes 96 configured to communicate with the respective cavities 22. The tab 181 of the mating terminal fitting 180 is inserted into each tab insertion hole 96 from front. The retainer 90 is assembled with the housing body 21 from below. The front mask portion 92 is stopped in contact with the projecting wall 25 from below.

### (Functions of Connector)

In connecting the housing 20 and the mating housing 100, the housing 20 is pushed forward toward the mating housing 100. Due to an installation environment of the connector 10 or the like, a worker may have to grip the housing 20 from both upper and lower sides in performing a connecting operation. Here, since the operating portion 33 of the lock arm 28 is arranged on the end surface 26 of the housing body 21, there is a concern that the worker's finger touches the operating portion 33 and the operating portion 33 is unexpectedly pushed down. On the other hand, in the case of this embodiment, the covering portion 41 is arranged to cover the entire operating portion 33 above the operating portion 33. Thus, in performing the connecting operation, a state where the finger F is placed on the covering portion 41 is reliably realized as shown in FIG. 2. In this way, the worker can perform the connecting operation, for example, by placing a thumb on the covering portion 41 and an index finger on a lower end part of the flange portion 38. Thus, the operating portion 33 can be prevented from being pushed down by the finger F of the worker during the connecting operation.

In a connection process of the housing 20, the lock projection 32 interferes with the receptacle 110 of the mating housing 100, whereby the lock arm 28 is resiliently deformed and the operating portion 33 is displaced downward toward the end surface 26 of the housing body 21. Here, connection resistance is generated due to the interference of the housing 20 and the mating housing 100 and the contact of the terminal fittings 80 and the mating terminal fittings 180. As shown in FIG. 2, the worker can press the respective step portions 43, 44 formed on the top surface 42 of the covering portion 41 from behind with the finger F against the connection resistance. Thus, the connecting operation can be performed without the finger F slipping on the top surface 42 of the covering portion 41. Further, as shown in FIG. 1, since each of the step portions 43, 44 has a trapezoidal or U shape in the plan view, the finger F can be placed over a wide range along the respective step portions 43, 44 and the respective step portions 43, 44 provide an effective anti-slip function for the finger F.

Thereafter, when the housing 20 reaches the proper connection position, the lock arm 28 resiliently returns and the respective arm bodies 29 having obtained a resilient reaction force of the lock arm 28 strike the inner wall (wall surface) of the receptacle 110 to generate a connection sound at the same time as the lock projections 32 are fit into the lock holes 111. The worker can judge that the housing 20 has reached the proper connection position by hearing this connection sound. That is, the worker can auditorily know the connected state of the connector 10.

In the case of separating the housing 20 and the mating housing 100 for maintenance or other reason, the lock arm 28 needs to be resiliently deformed in such an unlocking direction that the lock projections 32 come out from the lock holes 111. Normally, the worker can resiliently deform the lock arm 28 in the unlocking direction by pressing the facing surface 36, which is the upper surface of the operating portion 33, from above with a finger. However, since the covering portion 41 is arranged to cover the entire operating portion 33 above the operating portion 33 in the case of this embodiment, it is difficult to place the worker's finger on the facing surface 36 of the operating portion 33, but the groove portion 37 inclined downward toward the rear side is formed in the facing surface 36 of the operating portion 33. Thus, the lock arm 28 can be resiliently deformed in the unlocking direction by inserting a jig 200 into between the operating portion 33 and the covering portion 41 from behind and placing the jig 200 along the groove portion 37 as shown in FIG. 5. In this way, the housing 20 can be pulled away from the mating housing 100.

As described above, according to this embodiment, the finger F of the worker can be prevented from contacting the rear end part of the lock arm 28 by being placed on the top surface 42 of the covering portion 41 when the housing 20 and the mating housing 100 are connected. As a result, it can be avoided that the lock arm 28 is inadvertently resiliently deformed, and the lock arm 28 can properly resiliently return to generate a predetermined connection sound when the housing 20 reaches the proper connection position. Moreover, since the step portions 43, 44 provide the anti-slip function for the finger F when the housing 20 is pushed into the mating housing 100, the connecting operation can be smoothly performed.

Further, since the finger F of the worker can be placed along the trapezoidal or U-shaped steps 43, 44 projecting forward in this embodiment, a large hooking margin of the finger F to the step portions 43, 44 can be taken and the step portions 43, 44 provide an effective anti-slip function for the finger F. Moreover, since being formed into a ripple shape as a whole, each step portion 43, 44 is easily recognized as a part, on which the finger F is to be placed.

Furthermore, even if the operating portion 33 is covered by the covering portion 41, the connection of the housing 20 and the mating housing 100 can be properly released by placing the jig 200 along the groove portion 37 of the operating portion 33.

### Other Embodiments of Present Disclosure

The embodiment disclosed this time should be considered illustrative in all aspects, rather than restrictive.

In the case of the above embodiment, the plurality of step portions are formed on the top surface of the operating portion. In contrast, according to another embodiment, one step portion may be formed on a top surface of an operating portion.

In the case of the above embodiment, the step portion is formed into the trapezoidal or U shape in the plan view by the straight portion and the pair of inclined portions. In contrast, according to another embodiment, an entire step portion may be a straight portion and linearly formed in a plan view. Alternatively, the entire step portion may be formed into a curved shape in the plan view.

In the case of the above embodiment, the lock arm is resiliently deformed with the front end part coupled to the upper surface of the housing body as a fulcrum. In contrast, according to another embodiment, a lock arm may include a pair of support arms formed to protrude in intermediate parts in the front-rear direction and coupled to respective side portions and may be resiliently deformed like a seesaw with each support arm as a fulcrum.

In the case of the above embodiment, the lock arm includes the pair of arm bodies arranged at an interval in the lateral direction. In contrast, according to another embodiment, a lock arm may include one arm body continuous over an entire width in the lateral direction.

In the case of the above embodiment, the lock arm is resiliently deformed in the unlocking direction by placing the jig along the groove portion of the operating portion. In contrast, according to another embodiment, the lock arm may be resiliently deformed in the unlocking direction by placing a fingertip along the groove portion of the operating portion if the connector is a large-size connector.

### LIST OF REFERENCE NUMERALS

10 . . . connector
20 . . . housing
21 . . . housing body
21A . . . front surface
22 . . . cavity
23 . . . locking lance
24 . . . retainer mount hole
25 . . . projecting wall
26 . . . end surface
27 . . . recessed surface
28 . . . lock arm
29 . . . arm body
31 . . . coupling portion
32 . . . lock projection
33 . . . operating portion
34 . . . leg portion
35 . . . operating body
36 . . . facing surface
37 . . . groove portion
38 . . . flange portion
39 . . . side portion
41 . . . covering portion
42 . . . top surface
43 . . . first step portion (step portion)
44 . . . second step portion (step portion)
45 . . . straight portion
46 . . . inclined portion
47 . . . corner portion
48 . . . third flat surface
49 . . . second flat surface
51 . . . first flat surface
80 . . . terminal fitting
81 . . . connecting portion
82 . . . barrel portion
90 . . . retainer
91 . . . retainer body
92 . . . front mask portion
93 . . . side wall
94 . . . through hole
95 . . . retaining portion
96 . . . tab insertion hole
100 . . . mating housing
110 . . . receptacle
111 . . . lock hole
180 . . . mating terminal fitting
181 . . . tab
200 . . . jig
F . . . finger
W . . . wire

1. A connector, comprising a housing to be connected to a mating housing,
the housing including:
a lock arm extending from a front end to a rear end in a connection direction to the mating housing, the lock arm being resiliently deformable in an intersecting direction intersecting the connection direction, the lock arm being locked to the mating housing;
an end surface arranged to face a rear end part of the lock arm including the rear end in the intersecting direction;
a pair of side portions projecting on the end surface, the pair of side portions being arranged on both sides across the rear end part of the lock arm;
a covering portion bridged between the pair of side portions, the covering portion covering the rear end part of the lock arm from a side opposite to the end surface; and
a step portion formed to face rearward on a top surface opposite to a surface facing the lock arm in the covering portion.

2. The connector of claim 1, wherein:
the rear end part of the lock arm is arranged at a position more separated from the end surface than a part of the lock arm except the rear end part, and
the covering portion is formed to cover the entire rear end part of the lock arm when viewed from the side opposite to the end surface.

3. The connector of claim 1, wherein a plurality of the step portions are formed side by side in the connection direction on the top surface of the covering portion.

4. The connector of claim 1, wherein the step portion is formed into a trapezoidal or U shape when viewed from the side opposite to the end surface.

5. The connector of claim 1, wherein a plurality of the step portions are formed side by side in the connection direction on the top surface of the covering portion and each is formed into a trapezoidal or U shape when viewed from the side opposite to the end surface and has a ripple shape as a whole.

6. The connector of claim 1, wherein the rear end part of the lock arm includes a groove portion inclined in a direction away from the covering portion toward the rear side in a facing surface facing the covering portion.
